(19) United States
(12) Patent Application Publication
(10) Pub. No.: US 2012/0166472 A1
(43) Pub. Date: Jun. 28, 2012

(54) SYSTEM AND METHOD FOR COLLABORATIVE GRAPHICAL SEARCHING WITH TANGIBLE QUERY OBJECTS ON A MULTI-TOUCH TABLE

(75) Inventors: Yves Hoppenot, Notre-Dame-de-Mesage (FR); Tommaso Colombino, Grenoble (FR); Luca Marchesotti, Grenoble (FR); Gabriela Csurka, Crolles (FR); Grégoire Gerard, Villeurbanne (FR)

(73) Assignee: Xerox Corporation, Norwalk, CT (US)

(21) Appl. No.: 12/976,196

(22) Filed: Dec. 22, 2010

(51) Int. Cl. G06F 3/048; G06F 17/30

(52) U.S. Cl. 707/769; 707/E17.014

(57) ABSTRACT

A system and a method are disclosed for developing a query. The system includes a display device for displaying elements, such as images, textures, color palettes, ad textual elements, which are selectable as query elements for forming a query. A physical space is provided on the display in which a physical object can be positioned. At least one physical object is positioned in the physical space, which is recognized by the system as having an identifier stored in memory to which a query can be linked. A sensor is provided for detecting a physical manipulation of the physical object in the physical space which represents absorbing a query element into a query. A query generator generates a query based on the absorbed query element. The query is thus associated in memory with the identifier for the recognized object. In this way, several physical objects can be manipulated on the display device, each one corresponding to a respective, single query.

### BACKGROUND

The exemplary embodiment relates to image retrieval and finds particular application in connection with a computing system in which one or more tangible objects are used to represent a search query.

Graphic designers are often faced with the task of identifying suitable images for a document. The designer may have been presented with a design brief which outlines various requirements for the document, such as a theme, a color palette, textual content, fonts to be used, and the like. The task may thus entail finding images which match the color palette or predominant colors of the document or which complement the textual content of the document. The designer generally has access to a large collection of images, for example in an online database. Retrieving images for such graphic design applications from a large collection generally entails defining a search space within the collection through explicit criteria. While most image collections are tagged and allow users to perform target and textual query-based searches, some systems also allow image-query search and/or facet query refinement based on image metadata, which is textual. In the latter case, the refinement/search query is dependent on the database and is not applicable to other repositories. Some systems allow collaborative search based on textual-queries. These systems are web-based and do not allow any direct interaction between users.

In general, users have to translate the complex visual and conceptual requirements of a design brief into a textual query formulation, relying on the generic tagging and metadata provided to navigate the search space. Furthermore, the designer may need to keep a record of the different explorations and the search criteria which were used in order to preserve a record of how the conceptual requirements of a design brief have been translated into visual properties that can leveraged in search and retrieval and to enable aesthetic decisions to be shared with colleagues and customers for justifying the choices made.

There remains a need for a system and method which facilitate development of search queries, particularly in collaborative settings, for assisting designers and other users in the retrieval of responsive images from a collection.

### INCORPORATION BY REFERENCE

The following references, the disclosures of which are incorporated herein by reference, are mentioned:

U.S. Pat. No. 5,586,197, issued Dec. 17, 1996, entitled IMAGE SEARCHING METHOD AND APPARATUS THEREOF USING COLOR INFORMATION OF AN INPUT IMAGE, by Tsujimura, et al.; U.S. Pat. No. 6,175,954, issued Jan. 16, 2001, entitled COMPUTER PROGRAMMING USING TANGIBLE USER INTERFACE WHERE PHYSICAL ICONS (PHICONS) INDICATE: BEGINNING AND END OF STATEMENTS AND PROGRAM CONSTRUCTS; STATEMENTS GENERATED WITH RE-PROGRAMMABLE PHICONS AND STORED, by Lester David Nelson, et al.; U.S. Pat. No. 6,509,909, issued Jan. 21, 2003, and U.S. Pat. No. 6,732,915, issued May 11, 2004, both entitled SYSTEMS AND METHODS FOR CONTROLLING A PRESENTATION USING PHYSICAL OBJECTS, by Lester D. Nelson, et al.; U.S. Pat. No. 7,225,115, issued May 29, 2007, entitled COORDINATING HAPTICS WITH VISUAL IMAGES IN A HUMAN-COMPUTER INTERFACE, by Jake S. Jones; U.S. Pub. No. 20030021481, published Jan. 30, 2003, entitled IMAGE RETRIEVAL APPARATUS AND IMAGE RETRIEVING METHOD, by Eiji Kasutani; U.S. Pub. No. 20050149258, entitled ASSISTING NAVIGATION OF DIGITAL CONTENT USING A TANGIBLE MEDIUM, by Ullas Gargi; U.S. Pub. No. 20080052945, published Mar. 6, 2008, entitled PORTABLE ELECTRONIC DEVICE FOR PHOTO MANAGEMENT, by Michael Matas, et al.; U.S. Pub. No. 20090077488, published Mar. 19, 2009, entitled DEVICE, METHOD, AND GRAPHICAL USER INTERFACE FOR ELECTRONIC DOCUMENT TRANSLATION ON A TOUCH-SCREEN DISPLAY, by Bas Ording; U.S. application Ser. No. 12/480,002, filed on Jun. 8, 2009, entitled MANIPULATION OF DISPLAYED OBJECTS BY VIRTUAL MAGNETISM, b_{y} Caroline Privault, et al.; U.S. application Ser. No. 12/479,972, filed on Jun. 8, 2009, entitled SYSTEM AND METHOD FOR ASSISTED DOCUMENT REVIEW, by Caroline Privault, et al.; U.S. application Ser. No. 12/632,107, filed Dec. 7, 2009, entitled SYSTEM AND METHOD FOR CLASSIFICATION AND SELECTION OF COLOR PALETTES, by Luca Marchesotti, et al.; U.S. application Ser. No. 12/693,795, filed on Jan. 26, 2010, entitled A SYSTEM FOR CREATIVE IMAGE NAVIGATION AND EXPLORATION, b_{y} Sandra Skaff, et al. and U.S. application Ser. No. 12/890,049, filed on Sep. 24, 2010, entitled SYSTEM AND METHOD FOR IMAGE COLOR TRANSFER BASED ON TARGET CONCEPTS, by Sandra Skaff, et al.

### BRIEF DESCRIPTION

In accordance with one aspect of the exemplary embodiment, a system for developing a query includes a display device for displaying elements which are selectable as query elements for forming a query. A physical space is provided on the display in which a physical object is positionable. At least one physical object is positioned in the physical space as a physical representation of a query and which is recognized as having an identifier stored in memory. A sensor is provided for detecting a physical manipulation of the physical object in the physical space which represents absorbing a query element into a query. A query generator generates a query based on the absorbed query element, the query being associated in memory with the identifier for the recognized object.

In another aspect, a method for developing a query includes providing a physical space in which a physical object can be positioned, recognizing a physical object positioned in the physical space which represents a query, displaying a plurality of selectable query elements, detecting a physical manipulation of the physical object in the physical space, interpreting the detected physical manipulation as absorbing one of the selectable query elements into the query, and generating a query based on the absorbed query element, the query being associated in memory with an identifier for the recognized physical object.

In another aspect, a system for developing a query includes a display device for displaying images which are selectable as query elements for forming a query, a physical space on the display in which a physical object is positionable for selection of images as query elements, and at least one physical object which can be manipulated in the physical space and which is recognized as having an identifier stored in memory. Memory stores instructions for recognizing a manipulation as absorbing one of the images into a query associated with the physical object's identifier. A processor in communication with the memory implements the instructions. Manipulation of the physical object in the physical space, with respect to a selected one of the displayed images, causes the image to be absorbed into to the query.

### BRIEF DESCRIPTION OF THE DRAWINGS

FIG. 1 is a schematic view of system for search query development in accordance with one aspect of the exemplary embodiment;

FIG. 2 is a top plan view of a user interface and tangible query objects on a multi-touch table;

FIG. 3 is a perspective view which illustrates an exemplary tangible query object;

FIG. 4 is a flow diagram illustrating a method for search query development in accordance with another aspect of the exemplary embodiment;

FIG. 5 is a top plan view of the user interface and tangible query objects which illustrates selecting an image in the search space to define a search;

FIG. 6 illustrates a selected image on the user interface being visualized using the tangible query object;

FIG. 7 illustrates refining a query using meta data and a portion of a selected image;

FIG. 8 illustrates manual interaction with the multi-touch table;

FIG. 9 illustrates manipulating the tangible query object for accessing information on a selected graphical element; and

FIG. 10 illustrates a query composed of graphical elements displayed on the user interface.

### DETAILED DESCRIPTION

Aspects of the exemplary embodiment relate generally to tangible computing, and more particularly to the generation of a search query by manipulating one or more tangible (physical) objects that represent the query. Tangible computing is the manipulation of real, physical objects to instruct and control computers.

The exemplary tangible computing system provides for observation, by a computer, of a real, two or three-dimensional work space, where each tangible object can be assigned an identifier, and assignment of attributes to, and/or movement of, a tangible object can result in modification of the query. A computer program can be used by the system in which sensed manipulations of physical objects represent program language elements of a program or programming language.

In one aspect, the exemplary system enables single user searching or collaborative searching of stored graphical elements, such as images, color palettes, textures, other graphical elements, and the like, each graphical element, when displayed, being represented on the screen by an arrangement of colored pixels. The system may include an interaction mechanism incorporating a multi-touch device, one or more tangible objects, and optionally a set of image analysis tools, which may be implemented in the form of web services. The system is designed to support single users or multiple users in a collaborative search session. The users may be graphic designers, although other expert or non-expert users are also contemplated.

The interaction mechanism is used to define query elements for a search. This mechanism enables direct, tangible, multi-touch and multi-user manipulation of graphical elements. A tangible object can be shared by several users in generating a query, or several users can each participate in the generation of a query using respective tangible objects. Such capability provides the ability to form a portable “mood board”; a medium where the visual and conceptual elements relevant to a search and/or a design brief are dynamically stored in the course of a search session. The interaction mechanism can also be used to track the path and history of complex search queries and to facilitate complex query formulation while maintaining an intuitive and direct image browsing mechanism.

A user of the system can be any person, such as a graphical designer other expert user, or a non-expert user.

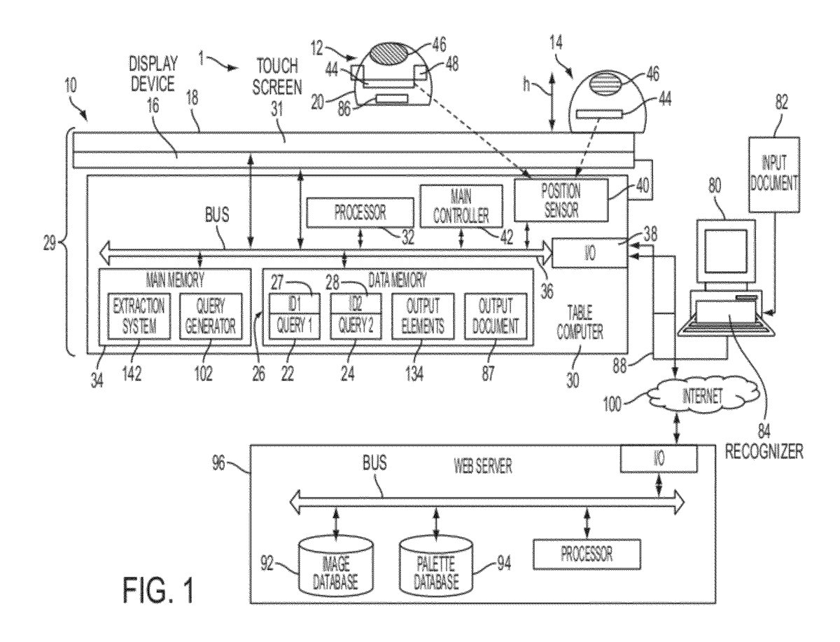

FIG. 1 illustrates a tangible object-based computing system 1. The system includes an interaction mechanism 10, which includes one or more tangible query objects (also referred to herein as “tangible objects” and “physical objects” or simply, “objects”) 12, 14. The interaction mechanism 10 also includes a display device 16, such as a color LCD, LED, or plasma screen. The tangible objects 12, 14 can be manipulated by hand and are movable, relative to each other and to the display device 16. The display device 16 defines a planar surface 18 on which the three-dimensional tangible query objects 12, 14 can be positioned. While FIG. 1 shows only two tangible query objects 12, 14, there may be any suitable number, such as two, three, four, five, six, or more tangible query objects. In the exemplary embodiment, the surface 18 is horizontally arranged and the tangible objects 12, 14 can simply rest on display surface 18, extending upwardly therefrom. When positioned on the display surface, a lower surface 20 of the tangible query object is thus in contact with and in the same plane as the screen surface 18. The tangible object can be grasped in a user's and manipulated to slide over the surface, rotate, and make other movements. The tangible query object 12, 14 may have a height h of at least 1 cm in a direction perpendicular to the plane of the surface 18. In other embodiments, the display 16 could be vertically or otherwise arranged and the tangible query objects 12, 14 attracted to the surface 18 through magnetism or the like. The tangible objects 12, 14 provide for direct manipulation of an intangible query 22, 24 and can provide the user with feedback through changes in physical shape, texture, and/or motion feedback.

In the exemplary embodiment, the tangible query objects 12, 14 do not store the query themselves. In general, they have no physical memory for receiving and storing data representative of a query. Rather, they are simply tangible representations of a query 22, 24 which is stored elsewhere in a memory storage device, such as data memory 26. Each object 12, 14 may have its own unique identifier (ID) 27, 28 through which the query 22, 24 is associated with the tangible object in memory 26. In the exemplary embodiment, each object 12, 14 is associated with no more than one query. The tangible object 12, 14 has a detectable attribute, such as a shape, a signal which is output by the tangible object, a barcode, or combination of attributes, which allows the tangible object 12, 14 to be recognized by the system 1 and associated with its respective unique identifier 27, 28.

The screen 16 forms a part of a search table 29, around which several users can gather. The search table 29 serves as a graphical user interface (GUI). The exemplary search table includes a computing device 30 (“table computer”) which interacts with the screen 16 and tangible query objects 12, 14. The search table 29 can be a multi-touch table which can receive inputs from several objects 12, 14 at a time. The search table 29 may also receive user inputs via a touch screen 31 incorporated into the display device 16. The exemplary table computer 30 includes a processor 32 and one or more memory storage devices, such as data memory 26 and main memory 34, which are connected by a data/control bus 36. The table computer 30 may also include one or more input/output interfaces (I/O) 38 for interacting with external devices. A presence/position sensor 40 and a controller 42 are integral with or in communication with the table computer 30.

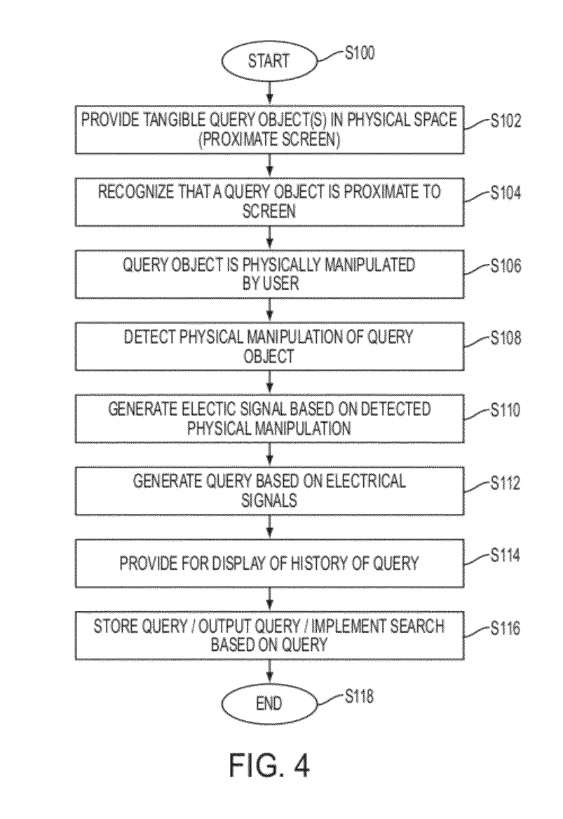

The main memory 34 stores software instructions for performing the exemplary method described below with reference to FIG. 4, which are executed by the processor 32. In particular, the processor 32 and memory 34 are configured for interpreting electrical signals from the position sensor 40 as query generation instructions, implementing feedback to the tangible query objects 12, 14 via the controller 42, interacting with the display screen 16 to display selectable query elements and the like, and storing the user-selected selected query elements in a query 22, 24 in memory 26.

The position sensor 40 detects the position (and/or presence) of each tangible query object 12, 14 which is on (or closely adjacent to) the table 29. The position may be detected relative to a fixed reference point, such as a point in the plane 18 of the display device 16. For providing its location, the exemplary tangible query object 12, 14 may include, as its attribute, a detectable element, such as a radio frequency identification (RFID) tag 44. The exemplary position sensor 40 is an RFID sensor which detects signals from the RFID tag 44. The RFID tag is mounted to the tangible query object 12, 14 and its signal corresponds to the object's unique ID 27, 28. The RFID 44 tags can be of any suitable configuration, such as a passive RFID tag, which requires an external electromagnetic field to initiate a signal transmission, an active (e.g., battery operated) RFID tag, which can transmit signals once the RFID sensor has been successfully identified, or a battery assisted passive RFID tag, which sends a signal when woken up by the sensor 40. The detectable element 44 may alternatively be detected by the system sensor 40 through Bluetooth, Wi-Fi, infrared radiation, or by wired or wireless connection.

In other embodiments, the position of each tangible query object 12, 14 is recognized by the system 1 and associated with the query ID through other attributes, such as physical characteristics of the tangible query object, such as its shape, weight, or the like. For example, the shape of the tangible object 12, corresponding to the object's lower surface 20, and/or its position and movement may be detected by the touch-actuated screen 31 forming the surface 18 of display device 16. In this embodiment, the surface 20 and/or perimeter of the object 12, 14 has a unique shape which does not change and the detected shape is compared to a stored different shape for each of the tangible objects 12, 14, etc. to identify the particular object 12 and hence associate manipulations on it with its unique ID. Touch screen systems which allow object detection which may be used herein are disclosed, for example, in above-mentioned U.S. Pub. No. 20090077488. One example of such a multi-touch table is the Microsoft Surface multi-touch computer. The touch-screen may use one or more cameras and/or image recognition in the infrared spectrum to recognize different types of objects such as the tangible objects. This input is then processed by the computer and the resulting interaction may be displayed using rear projection.

The tangible query object 12, 14 may include one or more feedback components 46, 48 which provide the user with a human-perceptible identifier of the query and/or an indication as to the status of the query. By way of example, each object 12, 14 includes a light source 46, such as an LED or LED array. This provides visual feedback to the user. The light 46 may illuminate with a particular color and/or provide an illuminated alphanumeric sequence, such as a digit or short string of textual information. This allows the user to distinguish one query 22 from another 24, for example, when there are multiple tangible query objects 12, 14 on the table 29. For example, the available query objects may be numbered from one to six. These numbers may, of course, be different from the unique ID 27, 28 of the respective query 22, 24 to which the tangible object 12, 14 corresponds. The light 46 may be illuminated in response to signals from the controller 42. To signal the status of a query, for example, a vibrator 48 vibrates in response to signals from the controller 42 to provide a tactile feedback signal to the user. Other types of feedback are also contemplated and can be selected from visual (light), aural (sound), tactile (vibration, shape, size, texture, temperature), or even smell feedback, or any combination of these.

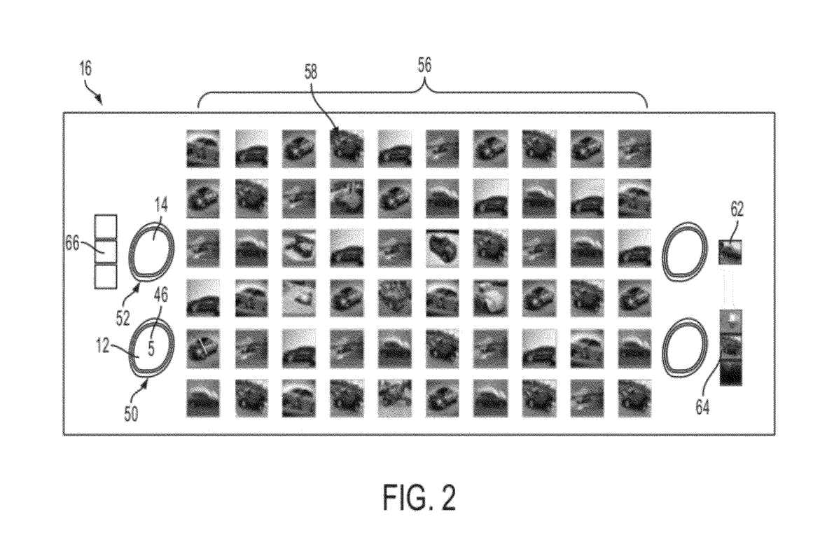

As illustrated in FIG. 2, each tangible query object 12, 14 (i.e., each query) may be assigned a respective docking area 50, 52, etc. on the screen 16. The docking areas 50, 52 are defined by an image displayed on the screen 16, i.e., by an area of suitably colored pixels. The location of each docking area is stored in memory 26, so that the system 1 is able to identify when a tangible object 12, 14 is located on its docking area (e.g., by the methods discussed above, such as the tangible object's RFID signal which can be identified by the sensor 40 as emanating from this location, the object's shape detected on the touch screen, or the like). The docking areas 50, 52 may be distinguished from each other by color, shape, size, or other visual identifier. This allows the user to recognize the correct docking area for placing his object 12, 14. For example, the docking areas may have the same color as the LED light 46 on the respective object. When a tangible query object 12, 14 is located in its docking area, 50, 52, the query is idle. Each docking area 50, 52 may have a shape which corresponds to that of the respective query object surface 20.

The screen 16 also displays a search area 56, in which retrieved visual assets, such as images, colors, textures, and the like, are displayed, e.g., in an array or other suitable configuration. In FIG. 2, the search space is shown as comprising an array 58 of displayed images, which may have been retrieved in response to a query generated through use of the tangible query object 12, 14, or otherwise. The user can select one or more of these displayed visual assets as graphical query elements. The graphical query elements in the exemplary embodiment can thus be selected from images, textures, and color palettes, i.e., to form visual parts of a query. The selected graphical query elements of a given query may be displayed adjacent the respective docking area 50, 52. For example, in FIG. 2, one graphical query element 62 is shown adjacent one docking area and three graphical query elements 64 are shown adjacent another docking area. The user can thus see which query elements have been added to his query through use of his tangible query object 12, 14. In addition to graphical query elements 62, 64, the screen 16 may also display one or more textual query elements 66. The textual query elements 66 may each correspond to a textual part of a query, such as a keyword(s), text document content, global positioning system (GPS) location, tags associated with images, stamp times associated with images, categories, and GPS locations or the like. As for the graphical query elements, the textual elements can be added to the query 22, 24 through the use of the tangible object 12, 14, as described in greater detail below. The set of displayed query elements (graphical and textual) belonging to a query may be highlighted with a color corresponding to the tangible object's color displayed by its LED light 46. The query elements 62, 64, 66 selected may be represented by icons. Each icon may represent a set of one or more selected query elements. Clicking on the icon (or manipulating the tangible object over it) displays the selected query elements of that type (e.g., images, texture, keywords, or GPS).

In the case of images as query elements 62, 64, each element (image) may include image data for an array of pixels forming the image. A thumbnail (reduced pixel resolution version) of an image stored elsewhere is considered to be an image for purposes of the description herein. The image data may include colorant values, such as grayscale values, for each of a set of color separations, such as L*a*b* or RGB, or be expressed in another other color space in which different colors can be represented. In general, “grayscale” refers to the optical density value of any single image data channel, however expressed (e.g., L*a*b*, RGB, YCbCr, etc.). The images may be photographs, video images, combined images which include photographs along with text, and/or graphics, or the like. The images may be stored in any suitable format, such as JPEG, GIF, JBIG, BMP, TIFF or other common file format used for images and which may optionally be converted to another suitable format during processing.

Textual query elements 66 may include a keyword or words, a representation of a document, e.g., based on a histogram of word counts, a location identifier, such as a global position (GPS) identifier, or the like.

With reference once more to FIG. 1, a user may also develop the query 22, 24, at least in part, through other computing devices, such as the user's workstation 80. The workstation recognizes the tangible object 12 as being present and allows the user to “drop” a document 82 elected therefrom) into it. By this, it is meant that the document 82, or graphical elements and/or textual elements extracted therefrom, is associated with the query 22 in memory 26. The exemplary workstation 80 includes a tangible object recognizer 84. The recognizer 84 may be implemented in software and hardware of the computer 80. The recognizer 84 may recognize any of the tangible objects 12, 14 when the tangible object is connected to the computer 80 through a wired or wireless connection, such as a USB, cable, proximity detection, RFID detection, or Bluetooth connection. This establishes a connection between the computer 80 and a microprocessor 86 (or other small computing device) within the tangible object. A user can transfer elements of a working document 82 to the query while the tangible query object 12 is proximate to or in communication with the computer 80. The query elements transferred are not stored on the tangible object 12 (or 14) itself, but rather are stored in the specific location 22 in memory 26 which is associated with the respective identifier 27 for the query object. Thus, the wired or wireless connection between the tangible object and the computer 80 is simply for identifying/confirming that the tangible object is proximate the computer and to allow the computer to identify the query 22/object ID 27 with which to associate the document 82. Then, the user unplugs the tangible object 12 and puts it on the search table 29 to improve the query and find new query elements for a search to obtain graphical elements for a document that he or she is creating. In other embodiments, the user can add query elements to the query without having the object present, for example, by inputting a reference to the object's unique ID.

The workstation 80 may thus be used for selecting the input document 82 to be used as the basis of a query. The document 82 may be selected from among the documents stored on the user's computer 80 or accessible via a network. The exemplary input document 82 may be a design brief. The purpose of a design brief is generally to provide visual and textual information which can be used by a graphic designer to generate a query 22 for retrieving appropriate graphical elements, such as images, colors, textures, and the like. The design brief 82 may include textual information which can be used in formulating a textual part of a query as well as graphics. The purpose is typically to create an output document 87, such as a brochure, advertising material, or the like. The textual information in the query may include a textual description of company, one or more keywords, or the like. The graphical information may include logos, photographic images, color palettes, and combinations thereof. A color palette generally includes swatches of a small set of colors, such as three to five colors, which are to be reflected in an output document 87. These can be stored as numerical color values and displayed as an unordered sequence of swatches, for example. The resulting output document 87 can incorporate the selected image(s), color(s), texture(s), or is at least based on them.

In other embodiments, the document 82 can be selected using the table computer 30, which may be linked to a document database via a network 88.

The table computer 30, or a separate computer in communication therewith, is configured for conducting a search in a database of visual assets, such as an image database 92 and/or a palette database 94. The image database 90 may include a large collection, e.g., millions, of photographic and/or other graphical images which may have been tagged with textual captions that describe the respective image. The palette database 94 may store a collection of predefined color palettes, usually designed by graphic designers to have complementary colors. These color palettes may also be tagged with textual captions. The databases 92, 94 may be publically accessible online resources stored on a web server 96. The web server may be accessed via a link such as the Internet 100. Alternatively or additionally, one or more of the databases 92, 94 may be internal databases, accessible, for example, via a local network server. In other embodiments, color palettes may be extracted from the images themselves, based on a represented selection of pixels, or otherwise associated with the image, e.g., by a graphic designer. In this case, some or all of the images in database 92 may be associated, in memory, with a respective color palette, e.g., as metadata.

A query generator 102 composes the selected query elements 62, 64, 66 into a query 22. The exemplary query generator 102 is in the form of software instructions stored in memory 34 of the table computer, which are executed by processor 32. The resulting query 22, which incorporates the user-selected query elements, is then formulated (either locally or on web server) into a searchable query in a suitable format for searching the databases, 92, 94.

As will be appreciated, while the components 26, 32, 34, 40, 42 are all shown physically located in a single computing device 30 located in the table 29, the components may be distributed over two or more communicatively linked computers. For example, one or more of the components shown may be located on a network server. The network server may be in communication with the table computer 30 (and user workstations 80) via a network 88, such as a wired or wireless local area network, cloud computing network, or the like.

The memory 26, 34 may represent any type of tangible computer readable medium such as random access memory (RAM), read only memory (ROM), magnetic disk or tape, optical disk, flash memory, or holographic memory. In one embodiment, the memory 26, 34, which may be separate or combined, comprises a combination of random access memory and read only memory. In some embodiments, the processor 32 and memory 34 may be combined in a single chip. The network interface 38 allows the computer 30 to communicate with other devices via a computer network, such as a local area network (LAN) or wide area network (WAN), or the internet, and may comprise a modulator/demodulator (MODEM). Memory 26, 34 stores instructions for performing the exemplary method as well as the retrieved assets to be displayed and the elements 62, 64, 66 of the query 22, 24 during its generation.

The digital processor 32 can be variously embodied, such as by a single-core processor, a dual-core processor (or more generally by a multiple-core processor), a digital processor and cooperating math coprocessor, a digital controller, or the like. The digital processor(s), in addition to controlling the operation of the computer(s), executes instructions stored in main memory 34, for performing the method outlined in FIG. 4.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

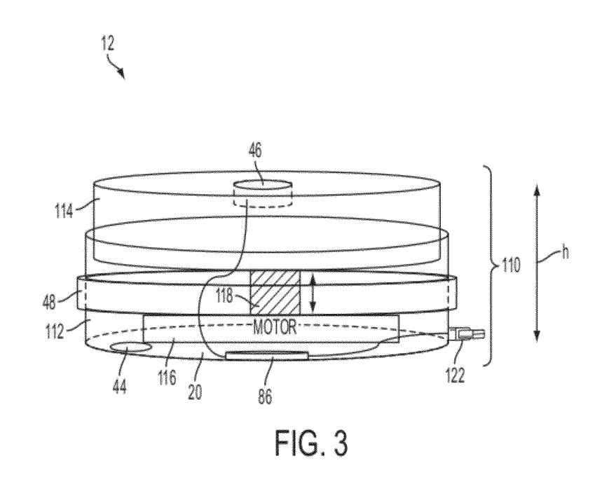

FIG. 3 illustrates an exemplary tangible object 12 in accordance with one specific embodiment. The tangible object 12 includes a casing 110 formed from a fabricated material such as metal, plastic, wood, or combination thereof. The casing has a planar lower surface 20 for sliding across the table surface 18. The exemplary casing 110 includes lower and upper telescoping parts 112, 114 which allow the casing to increase/decrease in height h between minimum and maximum heights, e.g., as a query 22 is increased in size. For example, a motor 116 in the lower casing 112 drives a drive shaft 118 operatively connected to the upper casing 114 (or vice versa), to elevate or lower the upper casing 114 relative to the lower casing 112. The motor 118 is controlled by the object's microprocessor 86, in response to signals from the main controller 42. The elevation may be controlled as a series of incremental steps, such that for each query element added, the casing increases in height by a visibly observable amount. Microprocessor 86 may also control actuation of the LED light 46 and/or vibrator 48 in response to signals received from main controller 42. A USB connector 122 may be provided which communicates with the microprocessor 86. This allows a unique ID stored in the microprocessor memory (or in RFID tag 44) to be communicated to workstation 80 to identify the query.

While the tangible object 12 shown in FIG. 3 is cylindrical, it is to be appreciated that the casing 110 may be more ergonomically designed, e.g., shaped more like a computer mouse or other graspable object. The shape and size of the object 12 allow the tangible object to be picked up by the user using only one hand and to be rotated using a simple hand movement. Additionally, users may be permitted to select from a set of suitable shaped objects according to their personal preference. Moreover, while the tangible object 12 is shown as including a microprocessor 86 and other powered interior/exterior components 44, 46, 48, 116, 118, in one embodiment, the tangible object 12 may have no electrical and/or moving mechanical parts and can be a solid (or hollow) object which is recognized by the system 1 simply by its shape or other attribute which requires no electrical signal. In this embodiment, the workstation may also have a touch screen to allow it to be used to add information to the query.

FIG. 4 illustrates a method for generating a query which may be performed with the exemplary system. The method begins at S100.

At S102 one or more tangible objects 12, 14 are provided, each object representing a query and being associated with a unique identifier. A graphical user interface 29 is also provided on which graphical elements are displayed.

At S104, the system recognizes one or more of the tangible object(s) 12, 14 which is/are placed into a physical space, such as on the surface 18 of the table, e.g., with position sensor 40 or a touch screen sensor.

At S106, one or more of the tangible object(s) is physically manipulated in the physical space, by a user, to represent absorbing of one or more displayed textual and/or graphical elements into a query as query elements. These manipulations may include moving the tangible object to the search area, positioning the tangible object on a graphical element for a threshold period of time, rotating the tangible object, or the like.

At S108, the physical manipulations are detected, e.g., by the position sensor 40 or a touch screen sensor.

At S110, electric signals are generated, e.g., by the position sensor 40, based on the detected physical manipulations. These signals are sufficient for the system to identify a tangible object and its location, and may further indicate a command to be performed by the system, e.g., based on a position, rotation, or other movement of the tangible object.

At S112, a query is generated, based, at least in part, on the electric signals. This may include identifying, from the signals, a particular object, associating that object with its query/ID and, also based on the signals, absorbing one or more query elements 62, 64, 66 into the identified query 22 or 24. Steps S106-S112 may be repeated one or more times until a user is satisfied with the query.

At S114, provision is made for the history of a query to be accessed and displayed.

At S116, the query may be stored in memory 26, output, and/or used to retrieve assets (graphical elements) from a database 92, 94 that are responsive to the query. These results may, in turn, be used to generate additional queries in the same manner, and/or used to produce an output document.

The method ends at S118.

The method illustrated in FIG. 4 may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 4, can be used to implement the method for query development.

Further details of the system and method will now be described.

Interactions with the Tangible Query Object (S106, S108)

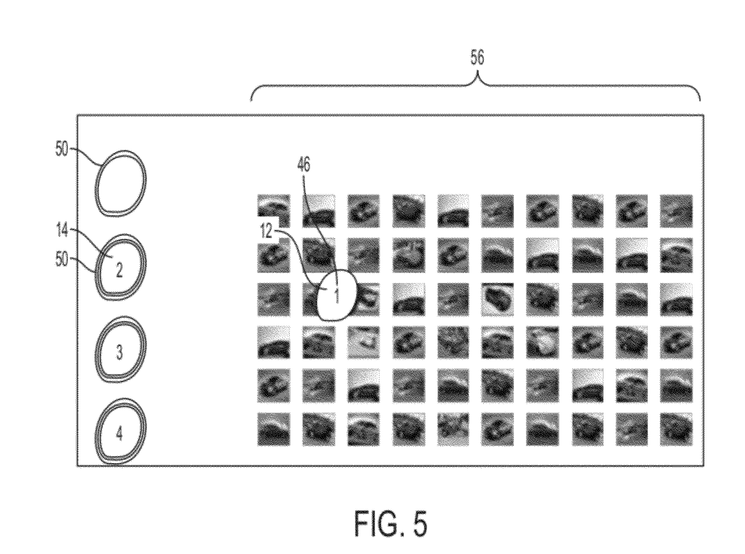

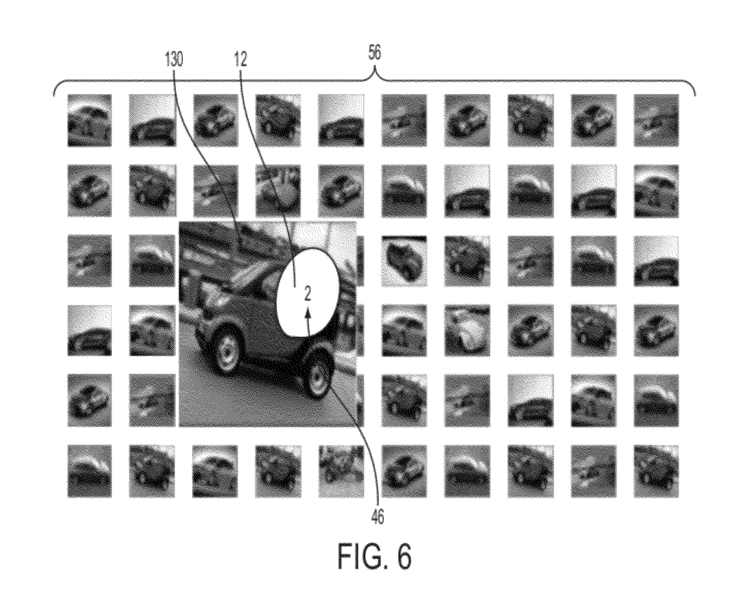

Various interactions with the tangible query object 12, 14 will now be described, by way of example. Various predefined physical manipulations and positions of the object are recognizable by the system 1 as a command. For example, moving the tangible object 12, 14 over the screen 16 (e.g., in an area where no selectable elements are displayed) starts a new search process (FIG. 5). The user may be informed that the search has begun with small vibration of vibrator 48 and/or flashing of the LED 46. Associating the object with a displayed element 130 such as an image, textual element, or the like (FIG. 6), tells the system 1 that the user wishes to absorb that element into a query. For example, putting down the tangible object 12, 14 (and/or holding it in one position for a short period of time) on a top of displayed element 130, causes the system 1 to absorb it into the query 22. When an image (or other graphical element) is “absorbed” into a query, the full image need not be stored in the query. For example, a thumbnail of the image, or a unique reference to an image stored elsewhere (such as a web link which is capable of retrieving the image), or an image signature extracted from the image, can be stored in the query. Each of these is considered to be absorbing the element into the query.

The absorption operation may also produce a feedback response in the tangible object 12, 14, such as a flash of the LED light 46 to signal to the user, for example, that the image has been absorbed into the query. Other user-perceptible feedback may be used, such as a sound, vibration, change in the tangible object's its physical appearance, such as a change in size, texture, shape, or the like. Combinations of these feedback signals can be used, for example, to signal different types of query elements, a complexity of the query, e.g., number of query elements, or the like.

The tangible query objects 12, 14 can be moved and stored physically anywhere. For example, a designer can store one or more objects 12, 14 at his or her workstation 80 and bring a relevant object 12, 14 or objects to the multi-touch table 29 to work with on a particular query. Other users can share the workspace, optionally, bringing their own objects 12, 14. The tangible object 12, 14 need not be personalized to any particular user and thus user authentication is not required. Rather, the system 1 operates through recognition of object 12, 14.

The user can browse images 58 returned by a search by manipulating the tangible object 12. Various predefined motions can be associated with navigation commands. For example, a simple motion of the hand to the left or to the right is detected as a command for browsing images, while clicking on a visual object, or movement of two fingers apart can be used for opening an image to view it in high resolution and to see its metadata and for zooming, respectively. In this way, the user can scroll up or down the displayed images or select an image to be viewed in an enlarged view. In the exemplary embodiment, these operations can be performed entirely by hand, without manipulating the tangible query object. In other embodiments, motions of the tangible query object can be used for browsing. The user can also “open” the query 22 to have a better view of its composition, e.g., by manipulating the tangible query object 12 on the table 29 with a predetermined motion (e.g., the user may turn it to the right). The user can then remove one of the selected query elements or return to a previous configuration of the query.

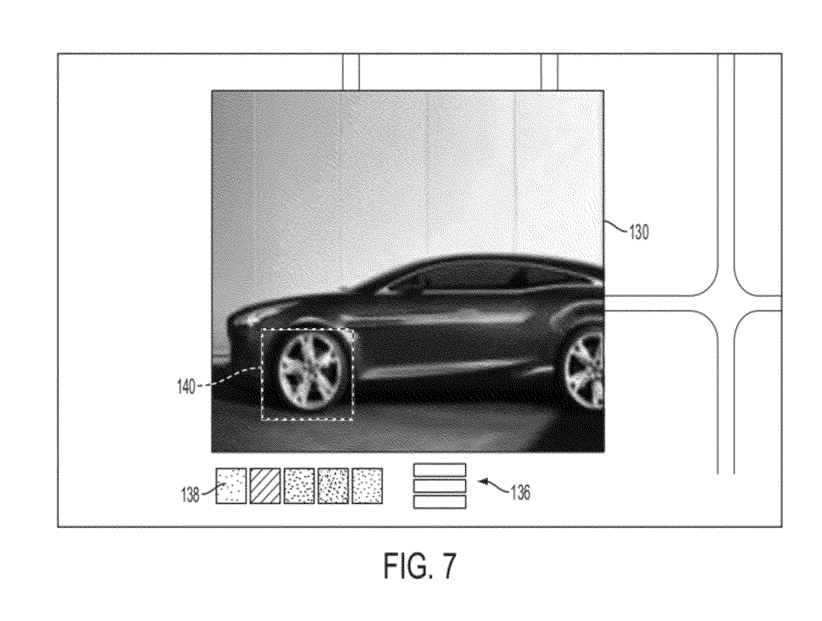

In an exemplary embodiment, each image 130 can be viewed in higher resolution by selecting it (FIG. 7). This view may also display information such as metadata 136 for the image, textual information such as tags, price, GPS information, and category, and graphical information, such as a respective color palette 138, most similar images, and the like. A user may select the image 130, or a portion 140 of the image 130 (e.g., by drawing a box around it in space with the tangible object or by zooming the image to fit a predefined rectangular bounding box), to serve as a new graphical query element 64. Additionally or alternatively, the user may select textual 136 or graphical 138 information associated with the image to serve as a textual/graphical query element.

The exemplary system 1 facilitates the exploration of the relationship and interaction between multiple queries, as the user can open several query objects 12, 14 on the search area. In one embodiment, all the resulting queries 22, 24 can be associated in a combined query and the system returns a set of images 58 corresponding to the combination of these queries. For example, an area of the display is designated as a query combination area. When two (or more) tangible objects 12, 14 are set down in this area, at the same time or sequentially, the queries associated with the two tangible objects are combined.

The physical representation of the query can improve the management of the query itself, since access to the tangible object 12, 14 controls access to the stored query 22, 24. Taking care of the tangible object 12, 14 thus corresponds to taking care of the query. Where appropriate, confidentiality can be preserved by hiding or storing the tangible object 12, 14 or by using an electronic locking mechanism which, for example, temporarily disables the RFID tag. The tangible object can serve as a “mood board” which can be semantically connected to the output document 87 produced. Sharing visual concepts and inspiration is facilitated.

The tangible query object 12, 14 can be used in collaboration/multi-user mode where several users are available at the same time around the search table 29. The various users may work on the same project together, searching, for example, for suitable photographic images 58. Any user can interact with a tangible query object 12 when she chooses to, in order to improve the query 22. The physical representation 12, 14 of the query helps to identify the current query actor and to organize the updating of the query automatically. Since only one user can act on the tangible query object 12 at a time, the query 22 can be updated in a sequential manner as the possession of the tangible object 12 changes.

Users may work on different projects or individual aspects of a shared project where they may need to share search criteria to inform their own individual queries 22, 24. In this embodiment, each user possesses a respective tangible query object 12, 14. By sharing the database visualization and by co-navigating the search space 58, users can easily absorb new elements 130 from the results of other people's queries 22, 24 for their own query. The query used for the search can also be changed by keeping previous navigation features.

The query 22, 24 may also have a graphical representation which can be directly manipulated, e.g., with a touch screen. Multiple graphical elements can be visualized on the screen at the same time, representing different queries. They can be moved on different locations over the screen and users can access the search elements contained within at any time.

In an exemplary embodiment, the search table 29 only serves as a search and visualization engine for digital assets. All the rest of the editing work typically performed on retrieved assets to integrate them in a design project may be performed elsewhere by the designer or by a team of designers. The exemplary system thus provides for the exchange of data between designers' workstations 80 and the search table.

### Single-User and Multiple-User Implementations

A single user implementation may proceed as follows. The user may independently retrieve digital assets based on a design brief 82 composed of images, text, and/or colors, which brief may be initially stored on the user's computer 80. The user plugs a tangible query object 12 into his computer and drops all the design brief data into it. The tangible object 12 physically grows in size (FIG. 3) when query elements are dropped into it and it takes a unique color to identify it. The user has an idea of the complexity of the search based on its physical appearance. The user goes to the table 29, bringing the tangible query object 12 with him. The user puts the tangible query on the table 29, e.g., in an empty docking area 50, 52, which causes the query object to be recognized by the table 29. The query object 12 may then display the same color (using its LED light) as is shown in the selected docking area. The user selects one or more databases in which he wants to search. Selected query elements 62, 64, 66 that have been absorbed into the query are displayed adjacent the corresponding docking area 50, 52. The search starts as soon as the tangible query object 12 is located in the search area 56. The tangible object vibrates to inform the user that the new search has begun. The user visualizes elements and navigates in a returned set of images through direct manipulation and optionally a navigation map. When the user finds one element (e.g., an image, palette, keyword, category, time, GPS . . . ) relevant for search refinement, he selects the image (clicks on it, e.g., with the hand or query object) and puts the tangible query object on top of it. A flash appears on the tangible object to inform the user that the new graphical element has been selected for the query. Since the graphical objects are only absorbed from the table into the query through possession and manipulation of the query object, and not simply with hand motions, this ensures that the graphical element is associated only with the query corresponding to that query object. The history of the query may be accessed at any time to check on the progress of the query.

The search is performed again and the result is displayed with the same features. When the user finds one or more graphical element(s) (e.g., image, palette, color) relevant for his work, he moves it to an output box 134 of the application in memory 26 (FIG. 1) in order to be able to find the graphical element(s) later to compose his document 87. When the search session is finished, the user takes the tangible query object 12 and goes back to his workstation area or leaves it by the table. By accessing the shared hard drive 26, he obtains the result 134 of his search.

A multiple-user implementation may proceed as follows. Two or more users may be involved in a brainstorming session to define the reel (reference images, colors and shapes) for a common design project. The two users are positioned around the multi-touch table 29. A tangible query object 12 is put down on the screen, on the search area 56 to be shared by both users. The tangible object may have been preloaded with one or more query elements by one of the users. A search is performed with an initial query 22. A small vibration indicates the end of the search and both users navigate and visualize the result. At any time, any one of the users can take possession of the tangible query object 12 and use it to absorb new elements into the query 22. A flash on the tangible object (and/or a size increase) indicates the addition of the new query element to the query. Adjacent the docking location 50, the selected new element 62, 64, 66 appears. The search can be refined in real time and the common query 22 (serving as a “mood board” of the project) is updated. Both users can evaluate the complexity of the query based on the physical appearance of the tangible object 12 and can open the query to review it by taking possession of the query object 12 and manipulating it. When the image set provided by the search result displays the expected search space 58 for the project, e.g., in terms of features (e.g., color, brightness, etc.) and image content, the users can stop their collaboration work. The freshly composed electronic query 22 can be shown to colleagues/managers or potential customers for validation. A third user may review the query results to find elements for a final document composition. The composed tangible query can be stored for future related projects. In a multi-user environment, there is greater degree of control of graphical elements provided by direct manipulation.

In yet another multiple-user implementation, multiple users each having a respective tangible object, manipulate their objects in the same search space to refine their respective queries.

### Query Formulation (S112)

The formulation of the query 22, 24 can include a variety of different aspects, such as text-based querying, image-based querying, and hybrid querying.

1. Text Based Querying

The user may start with a design brief 82 which may have been produced by the client of a design agency and posted on a web site. The design brief is transferred to multi-touch table. A typical brief contains a detailed description of the requirements of the client, in terms of look and feel, message to convey, and other semantic data. The design brief may be parsed with a parser, such as the Xerox Incremental Parser, to identify keywords for performing a textual search. The keyword(s) may be selected on the basis that it will retrieve at least one image from the database 92 (where images are indexed based on their tags or based on other automated extraction criteria. A semi-automated keyword extraction system 142 (FIG. 1) incorporating such a parser may be stored in memory 34 and implemented by the processor 32. System 142 may be configured to highlight potential keywords in the text to give the user the opportunity to select one or more of them, for example, by clicking on one or more of such keywords. The system may then retrieve images indexed with such keywords.

2. Keyword-Based Querying

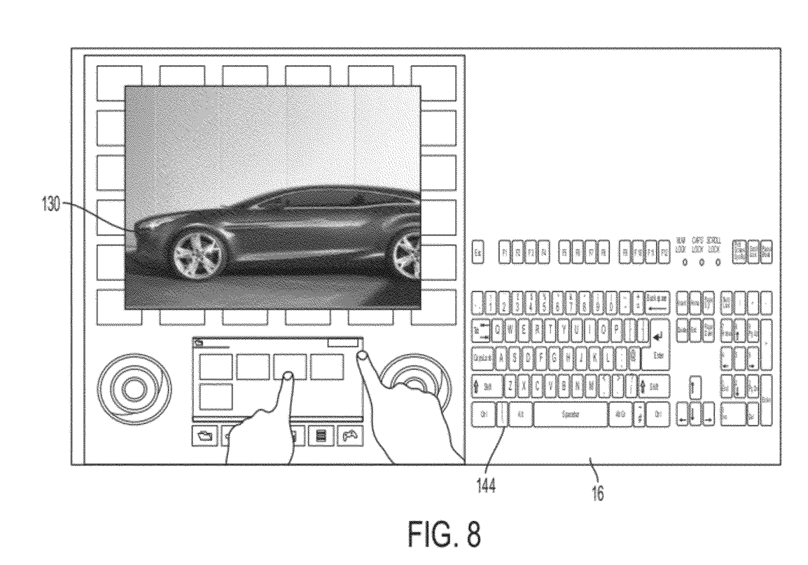

In one embodiment, a user may input one or more keywords, e.g., using a virtual keyboard 144 displayed on the screen (FIG. 8).

3. Example Based Querying

The user may have a design brief 82 composed of some reference images. In this embodiment, the user may start the search by retrieving images similar to the ones in the brief. The design brief may also include a color palette which can be used to retrieve similar palettes or images which use similar colors. The user may select one or multiple features to execute a query in a relevance-feedback mode. For example, the user may combine a keyword based query with an example-based one.

4. Hybrid Querying

The user may input one or multiple images, text or other image metadata (e.g. two or more of keywords, GPS, image, color palette, texture) together in a multimodal query. The results of such a query may be merged, e.g., with a late fusion strategy, by combining all the results collected by independent queries performed using the various modes (textual, image and metadata) with an appropriate weighting scheme. All these queries once formulated can be stored in the tangible object for future use or exchanged with other users.

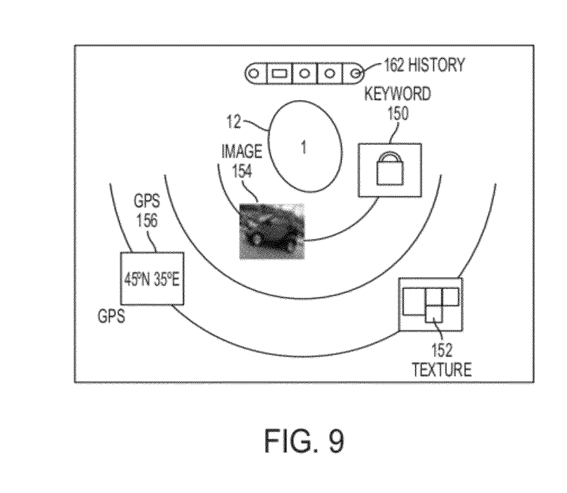

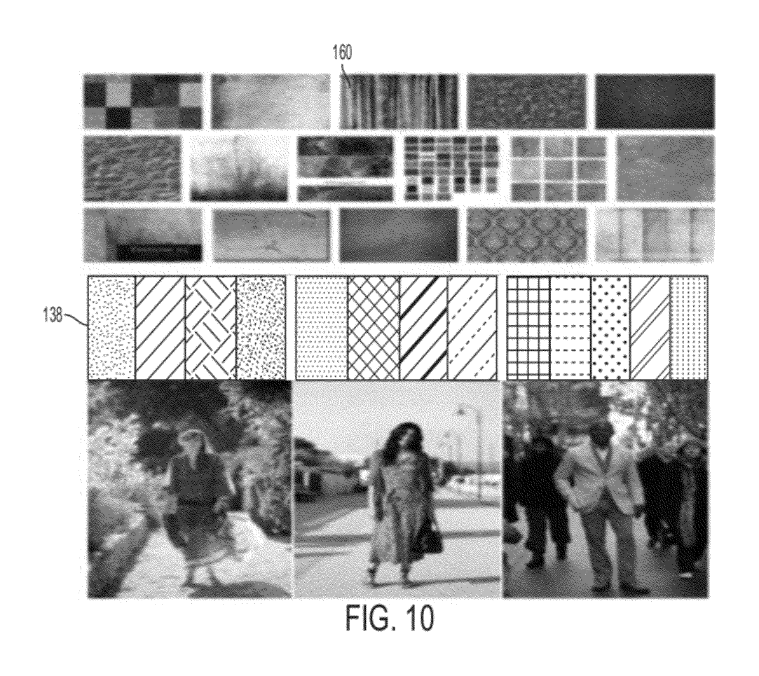

FIG. 9 shows an interface displayed on the screen for the formulation of hybrid queries. The user can select, using the tangible object or a touch screen interface (FIG. 8), one or more icons 150, 152, 154, 156 corresponding to text (e.g., metadata), color palettes/textures, natural images, and GPS. This opens up a new window where the criteria for this part of the query can be selected. The elements of the query e.g., composed by color palettes, natural images, and textures, as shown, may be displayed in a query space 160. FIG. 10 shows a query 160 comprising graphical elements built up from a plurality of images (here three), palettes (here three), and textures (here multiple textures). The results of each of these queries may be displayed in the search space 56.

All the possible query elements are established through software instructions stored in memory 34 in the system.

The query object 12, 14 is used to store the search query independently of the search area 29. The same query object can be used with different image databases and returns different images depending on the database used. The query object is thus focused on the goal to be reached (e.g., image to find, type of magazine to produce) and is not linked to the search context (e.g., graphical designer, specific databases). Since it is an individual object 12, 14 and others can exist at the same time, their stored contents can be easily copied or combined.

### Image Retrieval

Once a user is satisfied with a query 22, she can request that the query is submitted by the system 1 to retrieve responsive assets. In the case where the query includes an image or images 130, an image signature can be generated, which is a representation of the image that can be compared with corresponding signatures of the database images. An image similarity measure may be based on the distance between two image signatures, i.e., the query image and the database image. The exemplary system and method are not limited to any particular method for extracting image signatures. Exemplary methods are disclosed, for example, in following references, the disclosures of which are incorporated herein by reference in their entireties: U.S. Pub. Nos. 20030012428, 20030021481, 20060164664, 20070005356, 20070258648, 20080046410, 20080069456, 20090144033, 20100092084, 20100098343, 20100189354; U.S. Pat. No. 5,586,197; Gabriela Csurka, et al., “Visual Categorization with Bags of Keypoints,” ECCV Workshop on Statistical Learning in Computer Vision, 2004; Florent Perronnin, et al., “Fisher kernels on visual vocabularies for image categorization,” in CVPR, 2007; Florent Perronnin, et al., “Large-scale image categorization with explicit data embedding,” in CVPR 2010; Florent Perronnin, et al., “Large-scale image retrieval with compressed fisher vectors,” in CVPR 2010; Swain, M J and Ballard, D H (1991) “Color indexing” International Journal of Computer Vision 7(1), 11-32; D. M. Squire, W. Müller, H. Müller, and J. Raki, “Content-based query of image databases, inspirations from text retrieval: Inverted files, frequency-based weights and relevance feedback.” In Scandinavian Conference on Image Analysis, pp. 143-149, Kangerlussuaq, Greenland, June 1999; Chen Y., Wang J. Z., “A Region-Based Fuzzy Feature Matching Approach to Content Based Image Retrieval,” IEEE Transactions on Pattern Analysis and Machine Intelligence, vol. 24, no. 9, p. 1252-1267, September, 2002. These references provide methods for describing an image with an image signature based on extracted features. The references also describe methods for computing a score between two images based on the respective signatures. Some systems use global image descriptors based on color, such as or on color combined with texture, and shape. Other systems extract local features from image patches or segmented image regions and use techniques based on feature matching, build inverted files, bag-of visual words (BOV) or Fisher Vectors/Kernel representations. A Content-based image retrieval (CBIR) system where queries are formulated by visual examples through a graphical interface and content can be remotely accessed through web services is described, for example, in J. Fan, Y. Gao, H. Luo, D. A. Keim, and Z. Li, “A novel approach to enable semantic and visual image summarization for exploratory image search,” in ACM Conf. on Multimedia Information Retrieval, pages 358-365, Vancouver, 2008.

Images can alternatively or additionally be retrieved based on selected color palettes, as described, for example, in U.S. patent application Ser. No. 12/632,107, filed Dec. 7, 2009, entitled SYSTEM AND METHOD FOR CLASSIFICATION AND SELECTION OF COLOR PALETTES, by Luca Marchesotti, et al.

Other systems may be used, such as those which allow the user to query the system by drawing a sketch and then matching it in general with shapes and/or colors of images in the database. See, for example, Mathias Eitz, Kristian Hildebrand, Tamy Boubekeur and Marc Alexa, “A descriptor for large scale image retrieval based on sketched feature lines,” EUROGRAPHICS Sketch-Based Interfaces and Modeling (2009); Mathias Eitz, Kristian Hildebrand, Tamy Boubekeur and Marc Alexa, “PhotoSketch: A sketch based image query and compositing system,” ACM SIGGRAPH 2009 Talk Program; Watai Y. Yamasaki, T. Aizawa, K., “View-Based Web Page Retrieval using Interactive Sketch Query,” ICIP 2007; Query-by-Sketch Image Retrieval Using Similarity in Stroke Order, IEICE (E93-D), No. 6, pp. 1459-1469, June 2010. A query-by-icons system may be used in which the user places the icons on a canvas in the position where they should appear in the output document. See, for example, B. Moghaddam, Q. Tian, N. Lesh, C. Shen, and T. Huang. “Visualization and user-modeling for browsing personal photo libraries,” International Journal of Computer Vision, 56(1):109-130, 2004.

Textual queries, such as keyword searches can be used to retrieve images based on captions and tags associated with the images. Meta-data can be used to query the database or to visualize the results, such geographic location tags of images (Alexandar Jaffe, Mor Naaman, Tamir Tassa, and Marc Davis, “Generating Summaries and Visualization for Large Collections of GeoReferenced Photographs,” MIR'06 K. Toyama, R. Logan, and A. Roseway, “Geographic location tags on digital ages,” ACM Multimedia 2003, pages 156-166, 2003) or time series (D. Huynh, S. Drucker, P. Baudisch, and C. Wong, “Time quilt: scaling up zoomable photo browsers for large, unstructured photo collections” CHI Extended Abstracts 2005, pages 1937-1940, 2005).

All these features and image aspects can be integrated in the hybrid query formulation of the proposed system.

Fusion methods can be used to combine the outputs of textual and visual queries. See for example U.S. Pub. Nos. 2004026774; 20050050086, 20060239591, 20080010275 and 20100082615 and U.S. Pat. No. 7,242,810, incorporated herein by reference.

### History of a Query (S114)

The exemplary system 1 groups query elements and keeps track of the graphical designer's query choices. This allows the user to go back and forth in the search. The tangible query object 12, 14 retains a history of the query composition (e.g., the additions and deletions of query elements over time) which can, for example, help explain design choices to customers. As shown in FIG. 9, for example, the history of the query may be accessed through an icon 162 displayed on the screen 16.

Each query object has an associated memory location 22 to track any composition change of a query, e.g., when one query element is added or removed for example. Version management tools may be used to track the changes to the query. Storing the history of the query in this way reminds or informs the graphical designer of previous query formulation choices and gives the user freedom to test different search branches without destroying previous choices and to conduct exploration. The history also provides a way to offer proof to a third person about the choices made. This is particularly useful in developing a designer-customer relationship, where explaining decisions helps to establish the credentials of the designer.

The exemplary system and method provide a convenient and intuitive method for composing a complex query with graphical and textual elements. These elements can come from different sources of inspiration, such as an electronic document provided by a customer, one found on the web or already created by the designer, assets found during the search process, and combinations thereof. The query is “portable” through its association with a specific query object. The query can be comparable to a virtual “mood board,” i.e., a collage of visual elements which is meant to capture or represent the higher level semantic concepts of a design brief or project.

### EXAMPLE

The exemplary system (tangible user interface) was compared with existing systems for query development (multi-touch and mouse). Twelve participants completed manipulation and acquisition tasks on an interactive surface in each of three conditions: tangible user interface; multi-touch; and mouse. Interface control objects were easier to acquire in the tangible user interface than in the other systems and, once acquired, were easier to manipulate/more accurate. Qualitative analysis suggested that in the evaluated tasks, the tangible user interface offer greater adaptability of control and avoided a problem of exit error that can undermine fine-grained control in conventional multi-touch interactions.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for developing a query comprising:
a display device for displaying elements which are selectable as query elements for forming a query;
a physical space on the display in which a physical object is positionable;
at least one physical object which is positioned in the physical space as a physical representation of a query and which is recognized as having an identifier stored in memory;
a sensor for detecting a physical manipulation of the physical object in the physical space which represents absorbing a query element into the query;
a query generator for generating a query based on the absorbed query element, the query being associated in memory with the identifier for the recognized object.

2. The system of claim 1, wherein the selectable elements include at least one of graphical elements and textual elements.

3. The system of claim 2, wherein the selectable elements include graphical elements comprising at least one of images, color palettes, and textures.

4. The system of claim 2, wherein the selectable elements include textual elements comprising at least one of keywords, tags, stamp times, categories, and GPS locations.

5. The system of claim 1, wherein the physical object has an attribute from which the physical object is recognizable and wherein the sensor detects the attribute.

6. The system of claim 5, wherein the attribute comprises a signal output by the physical object which is detected by the sensor when the physical object is proximate the sensor.

7. The system of claim 6, wherein the signal comprises an RFID signal.

8. The system of claim 6, wherein the sensor detects the physical manipulation based on the signal.

9. The system of claim 5, wherein attribute comprises a shape and the sensor recognizes the shape.

10. The system of claim 9, wherein the sensor comprises a touch screen on the display device.

11. The system of claim 1, wherein the at least one physical object comprises a plurality of objects which are each positionable in the physical space and which are each recognizable as having a respective identifier stored in memory.

12. The system of claim 1, wherein the physical object comprises a feedback component configured for providing a user with at least one of a perceptible identifier the query and a perceptible indication of a status of the query.

13. The system of claim 12, wherein the feedback component comprises a mechanism for changing a shape of the physical object as query elements are added to the query.

14. The system of claim 1, wherein the query generator comprises software instructions stored in memory which are implemented by an associated processor.

15. The system of claim 1, wherein the display is configured for displaying a docking area for the physical object corresponding to an idle state of the query.

16. The system of claim 1, wherein at least one of the positioning of the physical object on a displayed graphical element and the movement of the physical object over a displayed graphical element serves to absorb the graphical element into the query as a query element.

17. A method for developing a query comprising:
providing a physical space in which a physical object is positionable;
recognizing a physical object positioned in the physical space which represents a query;
displaying a plurality of selectable query elements;
detecting a physical manipulation of the physical object in the physical space;
interpreting the detected physical manipulation as absorbing one of the selectable query elements into the query; and
generating a query based on the absorbed query element, the query being associated in memory with an identifier for the recognized physical object.

18. The method of claim 17, wherein the detecting of the physical manipulation comprises detecting at least one of a position and a movement of the physical object.

19. The method of claim 17, wherein the detecting a physical manipulation of the physical object comprises detecting an attribute of the physical object.

20. The method of claim 18, wherein the attribute comprises a signal output by the tangible object and the detecting a physical manipulation comprises detecting at least one of a position and a movement of the physical object based on the signal.

21. The method of claim 17, wherein the generating a query based on the absorbed query element is performed with a computer processor.

22. The method of claim 17, further comprising providing feedback to a user that he absorbed query element as been absorbed into the query.

23. The method of claim 17, wherein the query is portable with the physical object.

24. The method of claim 17, wherein the physical object comprises a plurality of physical objects, each being associated in memory with a respective query and the method comprises, with a first of the physical objects, absorbing a query element which has been retrieved with a search using a query generated from query elements absorbed by a second of the physical objects.

25. A computer program product comprising a non-transitory recording medium encoding instructions, which when executed on a computer causes the computer to perform the method of claim 17.

26. A system comprising memory which stores instructions for performing the method of claim 17 and a processor in communication with the memory for executing the instructions.

27. A system for developing a query comprising:
a display device for displaying images which are selectable as query elements for forming a query;
a physical space on the display in which a physical object is positionable for selection of images as query elements;
at least one physical object which is manipulable in the physical space and which is recognized as having an identifier stored in memory,
memory which stores instructions for recognizing a manipulation as absorbing one of the images into a query associated with the physical object's identifier; and
a processor in communication with the memory for implementing the instructions, wherein manipulation of the physical object in the physical space, with respect to a selected one of the displayed images, causes the image to be absorbed into to the query.
